(19) United States
(12) Patent Application Publication
(10) Pub. No.: US 2020/0066234 A1
(43) Pub. Date: Feb. 27, 2020

(54) VR Drawing Method, Device, and System

(71) Applicant: Huawei Technologies Co., Ltd., Shenzhen (CN)

(72) Inventor: Anli Wang, Taipei (TW)

(21) Appl. No.: 16/670,512

(22) Filed: Oct. 31, 2019

Related U.S. Application Data
(63) Continuation of application No. PCT/CN2017/083663, filed on May 9, 2017.

(51) Int. Cl. G09G 5/377; G06T 1/20; G09G 5/36

(52) U.S. Cl. CPC G09G 5/377; G09G 2340/10; G09G 5/363; G06T 1/20

(57) ABSTRACT

A virtual reality (VR) drawing method, device, and system in the field of drawing technologies, includes determining, by a terminal device, N^{th}-frame image data of a first drawing graphic and N^{th}-frame image data of a second drawing graphic, sending, by the terminal device, a drawing instruction to a VR device, creating, by the terminal device using the first GPU in the terminal device, an N^{th}-frame image of the second drawing graphic based on the N^{th}-frame image data of the second drawing graphic, sending, by the terminal device, the N^{th}-frame image of the second drawing graphic to the VR device, and sending, by the terminal device, a control instruction to the VR device.

### CROSS-REFERENCE TO RELATED APPLICATIONS

This application is a continuation application of International Patent Application No. PCT/CN2017/083663 filed on May 9, 2017, which is hereby incorporated by reference in its entirety.

### TECHNICAL FIELD

Embodiments of the present disclosure relate to the field of drawing technologies, and in particular, to a virtual reality (VR) drawing method, device, and system.

### BACKGROUND

A VR technology is a computer simulation system technology that enables creation and experience of a virtual world. The VR technology can create a virtual information environment in multi-dimensional information space using a graphics processing unit (GPU) of a terminal device and various interface devices such as display and control devices to provide a user with immersive experience.

In actual application, after a user wears a VR device and performs an operation on a terminal device, the user can view a picture (that is, a drawing graphic) of a three dimensional (3D) effect on a display screen of the VR device. FIG. 1 is a schematic diagram of a system architecture of a VR drawing system 1. As shown in FIG. 1, the VR drawing system 1 may include a terminal device 01 and a VR device 02. There is a communication connection between the terminal device 01 and the VR device 02. As shown in FIG. 1, the terminal device 01 includes a processor 10, a first GPU 20, a memory 30, and a bus 40. The VR device 02 includes displays. The displays are a first display 61 and a second display 62. A graphic presented to a left eye is obtained by the first GPU 20 by processing each frame of image of a drawing graphic corresponding to the left eye, and then is transmitted to the first display 61 for display. A graphic presented to a right eye is obtained by the first GPU 20 by processing each frame of image of a drawing graphic corresponding to the right eye, and then is transmitted to the second display 62 for display.

It can be learned from the foregoing that the graphics presented to the left eye and the right eye are both obtained by the first GPU 20 of the terminal device 01 through processing. However, a computing capability of the first GPU 20 is limited. Therefore, the first GPU 20 takes a relatively long time to process the graphics presented to the left eye and the right eye.

### SUMMARY

This application provides a VR drawing method, device, and system, to improve a drawing graphic processing capability.

To achieve the foregoing objective, the following technical solutions are used in this application.

According to a first aspect of this application, a VR drawing method is provided. The method includes determining, by a terminal device, N^{th}-frame image data of a first drawing graphic and N^{th}-frame image data of a second drawing graphic, where N is a positive integer greater than or equal to 1, sending, by the terminal device, a drawing instruction including the N^{th}-frame image data of the first drawing graphic to a VR device to instruct the VR device to establish, using a second GPU in the VR device, an N^{th}-frame image of the first drawing graphic based on the N^{th}-frame image data of the first drawing graphic, establishing, by the terminal device using a first GPU in the terminal device, an N^{th}-frame image of the second drawing graphic based on the N^{th}-frame image data of the second drawing graphic, sending, by the terminal device, the N^{th}-frame image of the second drawing graphic to the VR device to instruct the VR device to display the N^{th}-frame image of the second drawing graphic, and sending, by the terminal device, a control instruction to the VR device to instruct the VR device to synchronously display the N^{th}-frame image of the first drawing graphic. The N^{th}-frame image of the second drawing graphic and the N^{th}-frame image of the first drawing graphic are used to form an N^{th}-frame VR image. In this application, the first GPU in the terminal device and the second GPU in the VR device may respectively establish the N^{th}-frame image of the second drawing graphic and the N^{th}-frame image of the first drawing graphic, and the first GPU and the second GPU may establish the N^{th}-frame image of the second drawing graphic and the N^{th}-frame image of the first drawing graphic in parallel. Therefore, according to the method in this embodiment of the present disclosure, a time used for establishing an N^{th}-frame image of a drawing graphic is reduced, and a drawing graphic processing capability is improved. In addition, a VR core processing element is used to control the first GPU and the second GPU to synchronously send the N^{th}-frame images of the drawing graphics to displays of the VR device such that a first display and a second display synchronously display the N^{th}-frame VR image.

With reference to the first aspect, in a possible implementation of this application, the control instruction may include an N^{th} display moment. Correspondingly, sending, by the terminal device, a drawing instruction to a VR device may include determining, by the terminal device, an N^{th} drawing moment of the VR device based on the N^{th} display moment, and sending, by the terminal device, the drawing instruction to the VR device before the N^{th} drawing moment of the VR device. The N^{th} drawing moment of the VR device is earlier than the N^{th} display moment, and duration between the N^{th} drawing moment and the N^{th} display moment is greater than or equal to duration used by the second GPU to establish the N^{th}-frame image of the first drawing graphic. The terminal device may determine, based on the N^{th} display moment, a moment for sending the drawing instruction to the VR device such that the VR device can complete establishment of the N^{th}-frame image of the first drawing graphic before the N^{th} display moment or at the N^{th} display moment.

With reference to the first aspect and the foregoing possible implementation, in another possible implementation of this application, establishing, by the terminal device using a first GPU in the terminal device, an N^{th}-frame image of the second drawing graphic based on the N^{th}-frame image data of the second drawing graphic may include determining, by the terminal device, an N^{th} drawing moment of the terminal device based on the N^{th} display moment, and establishing, by the terminal device starting from the N^{th} drawing moment of the terminal device using the first GPU, the N^{th}-frame image of the second drawing graphic based on the N^{th}-frame image data of the second drawing graphic. The N^{th} drawing moment of the terminal device is earlier than the N^{th} display moment, and duration between the N^{th} drawing moment and the N^{th} display moment is greater than or equal to duration used by the first GPU to establish the N^{th}-frame image of the second drawing graphic. The terminal device may determine, based on the N^{th} display moment, a moment at which the terminal device starts to establish the N^{th}-frame image of the second drawing graphic such that the terminal device can complete establishment of the N^{th}-frame image of the second drawing graphic before the N^{th} display moment or at the N^{th} display moment.

With reference to the first aspect and the foregoing possible implementations, in another possible implementation of this application, before sending, by the terminal device, a drawing instruction to a VR device, the method in this application may further include receiving, by the terminal device, a synchronization signal that is sent by the VR device and that includes a current moment of the VR device, and adjusting, by the terminal device based on the current moment of the VR device, a current moment of the terminal device to be the same as the current moment of the VR device. After the terminal device adjusts the current moment of the terminal device to be the same as the current moment of the VR device, it can be ensured that when the terminal device sends the N^{th}-frame image of the second drawing graphic and the control instruction to the VR device, the VR device can synchronously display the N^{th}-frame image of the second drawing graphic and the N^{th}-frame image of the first drawing graphic at the N^{th} display moment.

With reference to the first aspect and the foregoing possible implementations, in another possible implementation of this application, determining, by a terminal device, N^{th}-frame image data of a first drawing graphic and N^{th}-frame image data of a second drawing graphic may include receiving, by the terminal device, sensor data transmitted by the VR device, and determining, by the terminal device, the N^{th}-frame image data of the first drawing graphic and the N^{th}-frame image data of the second drawing graphic that are corresponding to the sensor data. The N^{th}-frame image data of the first drawing graphic and the N^{th}-frame image data of the second drawing graphic are data that is obtained by the terminal device and that is generated after a user's head turns or moves, for example, a viewing angle of the user. Therefore, an image, of a drawing graphic, established by the terminal device based on the N^{th}-frame image data of the first drawing graphic and the N^{th}-frame image data of the second drawing graphic is an image that meets the user's desire, thereby improving VR experience of the user.

According to a second aspect of this application, a VR drawing method is provided. The method includes receiving, by a VR device, a drawing instruction that is sent by a terminal device and that includes N^{th}-frame image data of a first drawing graphic, where N is a positive integer greater than or equal to 1, establishing, by the VR device using a second GPU in the VR device, an N^{th}-frame image of the first drawing graphic based on the N^{th}-frame image data of the first drawing graphic, receiving, by the VR device, an N^{th}-frame image that is of a second drawing graphic and that is sent by the terminal device, receiving, by the VR device, a control instruction sent by the terminal device, and displaying, by the VR device, the N^{th}-frame image of the second drawing graphic, and synchronously displaying the N^{th}-frame image of the first drawing graphic according to the control instruction. The N^{th}-frame image of the second drawing graphic and the N^{th}-frame image of the first drawing graphic are used to form an N^{th}-frame VR image. In this application, the first GPU in the terminal device and the second GPU in the VR device may respectively establish the N^{th}-frame image of the second drawing graphic and the N^{th}-frame image of the first drawing graphic, and the first GPU and the second GPU may establish the N^{th}-frame image of the second drawing graphic and the N^{th}-frame image of the first drawing graphic in parallel. Therefore, according to the method in this embodiment of the present disclosure, a time used for establishing an N^{th}-frame image of a drawing graphic is reduced, and a drawing graphic processing capability is improved. In addition, a VR core processing element is used to control the first GPU and the second GPU to synchronously send the N^{th}-frame images of the drawing graphics to displays of the VR device such that a first display and a second display synchronously display the N^{th}-frame VR image.

With reference to the second aspect, in a possible implementation of this application, the control instruction may include an N^{th} display moment. Correspondingly, establishing, by the VR device using a second GPU in the VR device, an N^{th}-frame image of the first drawing graphic based on the N^{th}-frame image data of the first drawing graphic may include establishing, by the VR device starting from an N^{th} drawing moment of the VR device using the second GPU, the N^{th}-frame image of the first drawing graphic based on the N^{th}-frame image data of the first drawing graphic. The N^{th} drawing moment of the VR device is earlier than the N^{th} display moment, and duration between the N^{th} drawing moment and the N^{th} display moment is greater than or equal to duration used by the second GPU to establish the N^{th}-frame image of the first drawing graphic. The terminal device may determine, based on the N^{th} display moment, a moment for sending the drawing instruction to the VR device such that the VR device can complete establishment of the N^{th}-frame image of the first drawing graphic before the N^{th} display moment or at the N^{th} display moment.

With reference to the second aspect and the foregoing possible implementation, in another possible implementation of this application, before receiving, by a VR device, a drawing instruction sent by a terminal device, the method in this application may further include sending, by the VR device, a synchronization signal to the terminal device, where the synchronization signal includes a current moment of the VR device, and the synchronization signal is used to synchronize a current moment of the terminal device. The terminal device may adjust, based on the current moment of the VR device, the current moment of the terminal device to be the same as the current moment of the VR device to ensure that when the terminal device sends the N^{th}-frame image of the second drawing graphic and the control instruction to the VR device, the VR device can synchronously display the N^{th}-frame image of the second drawing graphic and the N^{th}-frame image of the first drawing graphic at the N^{th} display moment.

With reference to the second aspect and the foregoing possible implementations, in another possible implementation of this application, before establishing, by the VR device using a second GPU in the VR device, an N^{th}-frame image of the first drawing graphic based on the N^{th}-frame image data of the first drawing graphic, the method in this application may further include sending, by the VR device, sensor data to the terminal device, where the sensor data is used by the terminal device to determine the N^{th}-frame image data of the first drawing graphic and N^{th}-frame image data of the second drawing graphic. An image, of a drawing graphic, established by the terminal device based on the N^{th}-frame image data of the first drawing graphic and the N^{th}-frame image data of the second drawing graphic is an image that meets a user's desire, thereby improving VR experience of the user.

According to a third aspect of this application, a terminal device is provided. The terminal device may include a communications interface, a processor, and a first GPU. The processor may be configured to determine N^{th}-frame image data of a first drawing graphic and N^{th}-frame image data of a second drawing graphic, and generate a drawing instruction, where N is a positive integer greater than or equal to 1. The communications interface may be configured to send the drawing instruction including the N^{th}-frame image data of the first drawing graphic to a VR device to instruct the VR device to establish, using a second GPU in the VR device, an N^{th}-frame image of the first drawing graphic based on the N^{th}-frame image data of the first drawing graphic. The first GPU may be configured to establish an N^{th}-frame image of the second drawing graphic based on the N^{th}-frame image data of the second drawing graphic. The communications interface may be further configured to send the N^{th}-frame image of the second drawing graphic to the VR device to instruct the VR device to display the N^{th}-frame image of the second drawing graphic. The communications interface may be further configured to send a control instruction to the VR device to instruct the VR device to synchronously display the N^{th}-frame image of the first drawing graphic. The N^{th}-frame image of the second drawing graphic and the N^{th}-frame image of the first drawing graphic are used to form an N^{th}-frame VR image.

With reference to the third aspect, in a possible implementation of this application, the control instruction may include an N^{th} display moment. Correspondingly, the processor may be further configured to determine an N^{th} drawing moment of the VR device based on the N^{th} display moment, where the N^{th} drawing moment of the VR device is earlier than the N^{th} display moment, and duration between the N^{th} drawing moment and the N^{th} display moment is greater than or equal to duration used by the second GPU to establish the N^{th}-frame image of the first drawing graphic. The communications interface may be further configured to send the drawing instruction to the VR device before the N^{th} drawing moment of the VR device.

With reference to the third aspect and the foregoing possible implementation, in another possible implementation of this application, the processor may be further configured to determine an N^{th} drawing moment of the terminal device based on the N^{th} display moment, where the N^{th} drawing moment of the terminal device is earlier than the N^{th} display moment, and duration between the N^{th} drawing moment and the N^{th} display moment is greater than or equal to duration used by the first GPU to establish the N^{th}-frame image of the second drawing graphic. The first GPU may be further configured to establish, starting from the N^{th} drawing moment of the terminal device, the N^{th}-frame image of the second drawing graphic based on the N^{th}-frame image data of the second drawing graphic.

With reference to the third aspect and the foregoing possible implementations, in another possible implementation of this application, the communications interface may be further configured to receive a synchronization signal sent by the VR device before sending the drawing instruction to the VR device, where the synchronization signal includes a current moment of the VR device. The processor may be further configured to adjust, based on the current moment of the VR device, a current moment of the terminal device to be the same as the current moment of the VR device.

With reference to the third aspect and the foregoing possible implementations, in another possible implementation of this application, the communications interface may be further configured to receive sensor data transmitted by the VR device. The processor may be further configured to determine the N^{th}-frame image data of the first drawing graphic and the N^{th}-frame image data of the second drawing graphic that are corresponding to the sensor data.

With reference to the third aspect and the foregoing possible implementations, in another possible implementation of this application, the terminal device may further include a memory. The memory may be configured to store a computer executable instruction. The processor, the communications interface, the first GPU, and the memory are connected to each other using a bus. When the terminal device runs, the processor executes the computer executable instruction stored in the memory.

It should be noted that for detailed descriptions and benefit analysis of the function units in the third aspect and the possible implementations of the third aspect, reference may be made to corresponding descriptions and technical effects in the first aspect and the possible implementations of the first aspect. Details are not described herein again.

According to a fourth aspect of this application, a computer storage medium is provided. The computer storage medium stores program code of one or more parts. When at least one processor of the terminal device or the VR device in the third aspect executes the program code, the terminal device or the VR device may be driven to perform the VR drawing method according to the first aspect, the second aspect, and the corresponding optional embodiments. Optionally, the at least one processor may include at least one of the following a processor, a GPU, or a communications interface.

According to a fifth aspect of this application, a VR device is provided. The VR device may include a communications interface, a second GPU, and a display component. The communications interface may be configured to receive a drawing instruction that is sent by a terminal device and that includes N^{th}-frame image data of a first drawing graphic, where N is a positive integer greater than or equal to 1. The second GPU may be configured to establish an N^{th}-frame image of the first drawing graphic based on the N^{th}-frame image data of the first drawing graphic. The communications interface may be further configured to receive an N^{th}-frame image that is of a second drawing graphic and that is sent by the terminal device. The communications interface may be further configured to receive a control instruction sent by the terminal device. The display component may be configured to display the N^{th}-frame image of the second drawing graphic, and synchronously display the N^{th}-frame image of the first drawing graphic according to the control instruction. The N^{th}-frame image of the second drawing graphic and the N^{th}-frame image of the first drawing graphic are used to form an N^{th}-frame VR image.

With reference to the fifth aspect, in a possible implementation of this application, the control instruction may include an N^{th} display moment. Correspondingly, the second GPU may be further configured to establish, starting from an N^{th} drawing moment of the VR device, the N^{th}-frame image of the first drawing graphic based on the N^{th}-frame image data of the first drawing graphic. The N^{th} drawing moment of the VR device is earlier than the N^{th} display moment, and duration between the N^{th} drawing moment and the N^{th} display moment is greater than or equal to duration used by the second GPU to establish the N^{th}-frame image of the first drawing graphic.

With reference to the fifth aspect and the foregoing possible implementation, in another possible implementation of this application, the communications interface may be further configured to send a synchronization signal to the terminal device before receiving the drawing instruction sent by the terminal device, where the synchronization signal includes a current moment of the VR device, and the synchronization signal is used to synchronize a current moment of the terminal device.

With reference to the fifth aspect and the foregoing possible implementations, in another possible implementation of this application, the VR device may further include a sensor. The sensor may be configured to obtain sensor data before the second GPU establishes the N^{th}-frame image of the first drawing graphic based on the N^{th}-frame image data of the first drawing graphic, where the sensor data is used by the terminal device to determine the N^{th}-frame image data of the first drawing graphic and N^{th}-frame image data of the second drawing graphic. The communications interface may be further configured to send the sensor data to the terminal device.

It should be noted that for detailed descriptions and benefit analysis of the function units in the fifth aspect and the possible implementations of the fifth aspect, reference may be made to corresponding descriptions and technical effects in the second aspect and the possible implementations of the second aspect. Details are not described herein again.

According to a sixth aspect of this application, a VR drawing apparatus is provided. The VR drawing apparatus may include a determining module, a sending module, and an establishment module. The determining module may be configured to determine N^{th}-frame image data of a first drawing graphic and N^{th}-frame image data of a second drawing graphic, where N is a positive integer greater than or equal to 1. The sending module may be configured to send a drawing instruction including the N^{th}-frame image data of the first drawing graphic to a VR device, to instruct the VR device to establish, using a second GPU in the VR device, an N^{th}-frame image of the first drawing graphic based on the N^{th}-frame image data of the first drawing graphic. The establishment module may be configured to establish, using a first GPU in the terminal device, an N^{th}-frame image of the second drawing graphic based on the N^{th}-frame image data that is of the second drawing graphic and that is determined by the determining module. The sending module may be further configured to send the N^{th}-frame image that is of the second drawing graphic and that is established by the establishment module to the VR device to instruct the VR device to display the N^{th}-frame image of the second drawing graphic. The sending module may be further configured to send a control instruction to the VR device to instruct the VR device to synchronously display the N^{th}-frame image of the first drawing graphic. The N^{th}-frame image of the second drawing graphic and the N^{th}-frame image of the first drawing graphic are used to form an N^{th}-frame VR image.

With reference to the sixth aspect, in a possible implementation of this application, the control instruction may include an N^{th} display moment. Correspondingly, the sending module may be further configured to determine an N^{th} drawing moment of the VR device based on the N^{th} display moment, and send the drawing instruction to the VR device before the N^{th} drawing moment of the VR device. The N^{th} drawing moment of the VR device is earlier than the N^{th} display moment, and duration between the N^{th} drawing moment and the N^{th} display moment is greater than or equal to duration used by the second GPU to establish the N^{th}-frame image of the first drawing graphic.

With reference to the sixth aspect and the foregoing possible implementation, in another possible implementation of this application, the establishment module may be further configured to determine an N^{th} drawing moment of the terminal device based on the N^{th} display moment, and establish, starting from the N^{th} drawing moment of the terminal device using the first GPU, the N^{th}-frame image of the second drawing graphic based on the N^{th}-frame image data that is of the second drawing graphic and that is determined by the determining module. The N^{th} drawing moment of the terminal device is earlier than the N^{th} display moment, and duration between the N^{th} drawing moment and the N^{th} display moment is greater than or equal to duration used by the first GPU to establish the N^{th}-frame image of the second drawing graphic.

With reference to the sixth aspect and the foregoing possible implementations, in another possible implementation of this application, the VR drawing apparatus in this application may further include a receiving module and an adjustment module. The receiving module may be configured to receive a synchronization signal sent by the VR device before the sending module sends the drawing instruction to the VR device, where the synchronization signal includes a current moment of the VR device. The adjustment module may be configured to adjust, based on the current moment of the VR device, a current moment of the terminal device to be the same as the current moment of the VR device.

With reference to the sixth aspect and the foregoing possible implementations, in another possible implementation of this application, the determining module may be further configured to receive sensor data transmitted by the VR device, and determine the N^{th}-frame image data of the first drawing graphic and the N^{th}-frame image data of the second drawing graphic that are corresponding to the sensor data.

It should be noted that function units in the sixth aspect and the possible implementations of the sixth aspect in this embodiment of the present disclosure are obtained by logically dividing the VR drawing apparatus, to perform the VR drawing method in the first aspect and the optional manners of the first aspect. For detailed descriptions and benefit analysis of the function units in the sixth aspect and the possible implementations of the sixth aspect, refer to the corresponding descriptions and technical effects in the first aspect and the possible implementations of the first aspect. Details are not described herein again.

According to a seventh aspect of this application, a VR drawing apparatus is provided. The VR drawing apparatus may include a receiving module, an establishment module, and a display module. The receiving module may be configured to receive a drawing instruction that is sent by a terminal device and that includes N^{th}-frame image data of a first drawing graphic, where N is a positive integer greater than or equal to 1. The establishment module may be configured to establish, using a second GPU in a VR device, an N^{th}-frame image of the first drawing graphic based on the N^{th}-frame image data of the first drawing graphic. The receiving module may be further configured to receive an N^{th}-frame image that is of a second drawing graphic and that is sent by the terminal device. The receiving module may be further configured to receive a control instruction sent by the terminal device. The display module may be configured to display the N^{th}-frame image that is of the second drawing graphic and that is received by the receiving module, and synchronously display, according to the control instruction, the N^{th}-frame image that is of the first drawing graphic and that is established by the establishment module. The N^{th}-frame image of the second drawing graphic and the N^{th}-frame image of the first drawing graphic are used to form an N^{th}-frame VR image.

With reference to the seventh aspect, in a possible implementation of this application, the control instruction may include an N^{th} display moment. Correspondingly, the establishment module may be further configured to establish, starting from an N^{th} drawing moment of the VR device using the second GPU, the N^{th}-frame image of the first drawing graphic based on the N^{th}-frame image data of the first drawing graphic. The N^{th} drawing moment of the VR device is earlier than the N^{th} display moment, and duration between the N^{th} drawing moment and the N^{th} display moment is greater than or equal to duration used by the second GPU to establish the N^{th}-frame image of the first drawing graphic.

With reference to the seventh aspect and the foregoing possible implementation, in another possible implementation of this application, the VR drawing apparatus in this application may further include a sending module. The sending module may be configured to send a synchronization signal to the terminal device before the receiving module receives the drawing instruction sent by the terminal device, where the synchronization signal includes a current moment of the VR device, and the synchronization signal is used to synchronize a current moment of the terminal device.

With reference to the seventh aspect and the foregoing possible implementations, in another possible implementation of this application, the sending module may be further configured to send sensor data to the terminal device before the establishment module establishes the N^{th}-frame image of the first drawing graphic based on the N^{th}-frame image data of the first drawing graphic, where the sensor data is used by the terminal device to determine the N^{th}-frame image data of the first drawing graphic and the N^{th}-frame image data of the second drawing graphic.

It should be noted that function units in the seventh aspect and the possible implementations of the seventh aspect in this embodiment of the present disclosure are obtained by logically dividing the VR drawing apparatus, to perform the VR drawing method in the second aspect and the optional manners of the second aspect. For detailed descriptions and benefit analysis of the function units in the seventh aspect and the possible implementations of the seventh aspect, refer to the corresponding descriptions and technical effects in the second aspect and the possible implementations of the second aspect. Details are not described herein again.

According to an eighth aspect of this application, a VR drawing system is provided. The VR drawing system may include the terminal device according to the first aspect and the possible implementations of the first aspect, and the VR device according to the second aspect and the possible implementations of the second aspect.

### BRIEF DESCRIPTION OF DRAWINGS

FIG. 1 is a schematic diagram of a system architecture of a VR drawing system;

FIG. 2 is a schematic diagram of a system architecture of a VR drawing system according to an embodiment of the present disclosure;

FIG. 3 is a schematic structural diagram of a VR device according to an embodiment of the present disclosure;

FIG. 4 is a schematic diagram of an interaction process between a module or a component of a terminal device and a module or a component of a VR device according to an embodiment of the present disclosure;

FIG. 5A and FIG. 5B are a flowchart 1 of a VR drawing method according to an embodiment of the present disclosure;

FIG. 6 is a schematic diagram of an example in which a user changes an angle of viewing an N^{th}-frame image of a drawing graphic according to an embodiment of the present disclosure;

FIG. 7A and FIG. 7B are a flowchart 2 of a VR drawing method according to an embodiment of the present disclosure;

FIG. 8 is a schematic diagram of an example in which a VR core processing element determines an N^{th} drawing moment of a VR device according to an embodiment of the present disclosure;

FIG. 9 is a schematic diagram of an example in which a VR core processing element determines an N^{th} drawing moment of a terminal device according to an embodiment of the present disclosure;

FIG. 10A and FIG. 10B are a flowchart 3 of a VR drawing method according to an embodiment of the present disclosure;

FIG. 11 is a possible schematic diagram 1 of a VR drawing apparatus according to an embodiment of the present disclosure;

FIG. 12 is a possible schematic diagram 2 of a VR drawing apparatus according to an embodiment of the present disclosure;

FIG. 13 is a possible schematic diagram 3 of a VR drawing apparatus according to an embodiment of the present disclosure; and

FIG. 14 is a possible schematic diagram 4 of a VR drawing apparatus according to an embodiment of the present disclosure.

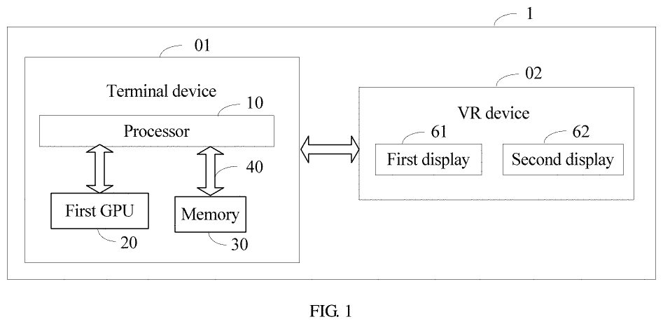

### DESCRIPTION OF EMBODIMENTS

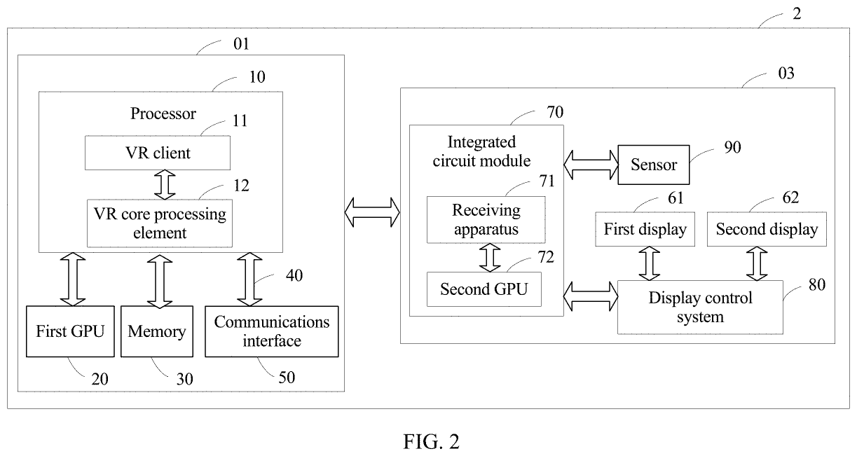

An embodiment of the present disclosure provides a VR drawing system 2. As shown in FIG. 2, the VR drawing system 2 may include a terminal device 01 and a VR device 03.

As shown in FIG. 2, the terminal device 01 includes a processor 10, a first GPU 20, a memory 30, a bus 40, and a communications interface 50. A VR client 11 and a VR core processing element 12 run on the processor 10.

The VR device 03 may include displays (for example, a first display 61 and a second display 62), an integrated circuit module 70, a display control system 80, and a sensor 90. The integrated circuit module 70 includes a receiving apparatus 71 and a second GPU 72. The receiving apparatus 71 and the second GPU 72 in this embodiment of the present disclosure may further run on a system on chip (SoC).

The terminal device 01 may be connected to the VR device 03 in a wired or wireless manner. The processor 10, the memory 30, and the first GPU 20 may be connected to each other using the bus 40. The bus 40 may be a peripheral component interconnect (PCI) bus, an extended industry standard architecture (EISA) bus, or the like. The bus 40 may include an address bus, a data bus, a control bus, and the like.

The processor 10 is a control center of the terminal device 01, and may be a processor, or may be a collective name of a plurality of processing elements. For example, the processor 10 may be a central processing unit (CPU), or may be an application-specific integrated circuit (ASIC), or one or more integrated circuits configured to implement the embodiments of the present disclosure, for example, one or more microprocessors, one or more digital signal processors (DSPs), or one or more field programmable gate arrays (FPGAs). The processor 10 may perform various functions of the terminal device 01 by running or executing a software program stored in the memory 30, and invoking data stored in the memory 30.

Further, the VR client 11 and the VR core processing element 12 run on the processor 10. The VR client 11 is a VR application program of the terminal device 01, and the VR client 11 may interact with a user. For example, the VR client 11 may be configured to obtain an operation instruction of the user, and obtain image data of a drawing graphic according to the operation instruction of the user, for example, N^{th}-frame image data of a first drawing graphic and N^{th}-frame image data of a second drawing graphic in this embodiment of the present disclosure. N is a positive integer greater than or equal to 1. The VR core processing element 12 is an image processing operating system of the terminal device 01, and the VR core processing element 12 may interact with the VR client 11 to obtain corresponding data, and control the first GPU 20 and the second GPU 72 to process a drawing graphic.

The first GPU 20 and the second GPU 72 each is an image processor, and may be configured to process a drawing graphic. For example, the first GPU 20 may be configured to establish an image of the first drawing graphic, and the second GPU 72 may be configured to establish an image of the second drawing graphic.

The memory 30 may be configured to store at least one of running data or a software module in the terminal device 01. For example, the memory 30 may be configured to store N^{th}-frame image data of a drawing graphic provided in this embodiment of the present disclosure.

The communications interface 50 is a channel for data and instruction transmission. For example, the communications interface 50 may be configured to transmit a drawing instruction in this embodiment of the present disclosure.

The first display 61 and the second display 62 are output devices, and are display tools that display data in a device on a screen for reflection to human eyes. For example, each display may be a liquid crystal display (LCD) or a corresponding display drive circuit. The first display 61 and the second display 62 may be configured to display a drawing graphic. For example, the first display 61 may be configured to display an N^{th}-frame image of the first drawing graphic, and the second display 62 may be configured to display an N^{th}-frame image of the second drawing graphic.

The sensor 90 is a detection apparatus that can sense measured information, and can convert the sensed information into an electrical signal or information in another required form according to a specific rule for output, to meet requirements for information transmission, processing, storage, display, recording, control, and the like. The sensor 90 may be configured to sense turning or moving of a user's head, obtain image data of a drawing graphic that changes after the turning or the moving of the user's head, and transmit the obtained image data of the drawing graphic to the VR client using the VR core processing element 12. In this embodiment of the present disclosure, the sensor 90 is used to sense the turning or the moving of the user's head to obtain the image data of the drawing graphic that changes after the turning or the moving of the user's head.

The receiving apparatus 71 may be a communications interface configured to receive data, an instruction, or the like sent by the terminal device 01. For example, the receiving apparatus 71 may be configured to receive a drawing instruction that is sent by the terminal device 01 and that includes the N^{th}-frame image data of the first drawing graphic. The receiving apparatus 71 may further interact with the second GPU 72 to transmit the received data or instruction to the second GPU 72. For example, the receiving apparatus 71 may be a wired communications interface or a wireless communications interface, and is coupled to and works collaboratively with the communications interface 50. Various types of signals or data may be transmitted between the terminal device 01 and the receiving apparatus 71 using the communications interface 50. When both the communications interface 50 and the receiving apparatus 71 are wireless communications interfaces, wireless communication protocols such as WI-FI, BLUETOOTH, and infrared near field communication (NFC) or various other cellular wireless communication protocols may be supported.

The display control system 80 may be configured to generate a synchronization signal, and may be further configured to process an image of a drawing graphic. For example, the display control system 80 may be configured to generate a synchronization signal provided in this embodiment of the present disclosure. The display control system 80 may be further configured to scan each pixel of the N^{th}-frame image of the second drawing graphic in this embodiment of the present disclosure. To be specific, the display control system 80 identifies or processes each pixel, and transmits a result of the scanning to the second display 62 in the VR device for display.

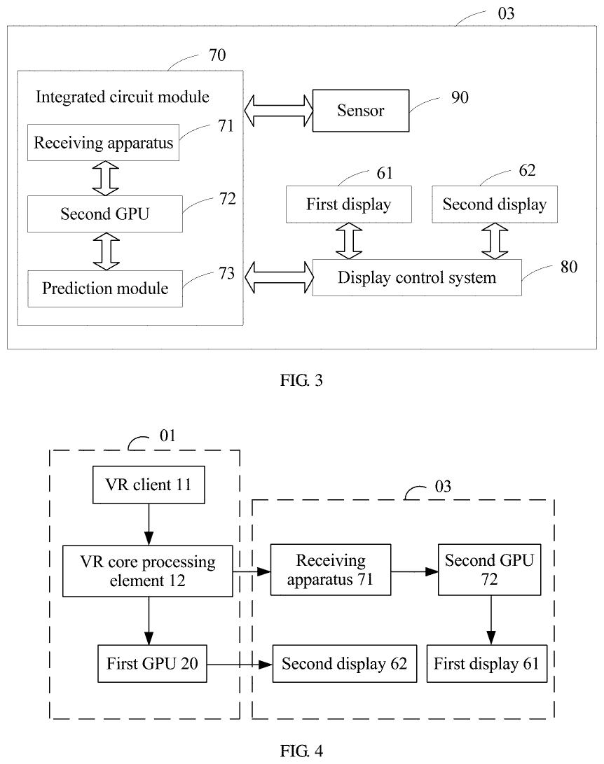

Further, as shown in FIG. 3, the integrated circuit module 70 of the VR device 03 in FIG. 2 may further include a prediction module 73. The prediction module 73 may be configured to predict an angle of viewing a drawing graphic of a user, and send a prediction result to the VR core processing element 12. The VR core processing element 12 sends the prediction result to the VR client 11, and the VR client 11 determines image data of the drawing graphic based on the prediction result, and sends the image data to the VR core processing element 12 such that the VR core processing element 12 can control the first GPU 20 and the second GPU 72 to process the drawing graphic based on the prediction result. The prediction module 73 may be a processor or a hardware accelerometer.

The following briefly describes an interaction process between modules or components in FIG. 2 based on FIG. 4. It should be noted that a drawing graphic of a 3D effect viewed by the user on the display of the VR device 03 is obtained by the GPU by processing each frame of image of the drawing graphic. After processing one frame of image of the drawing graphic, the GPU continues to process a next frame of image of the drawing graphic. In FIG. 4, a VR drawing method is described only using an example in which the GPU processes an N^{th}-frame image of a drawing graphic.

Further, as shown in FIG. 4, the VR client 11 may determine N^{th}-frame image data of the drawing graphic based on an operation instruction of the user (for example, the N^{th}-frame image data of the first drawing graphic and the N^{th}-frame image data of the second drawing graphic). The N^{th}-frame image data of the drawing graphic may come from the sensor 90, for example, captured data of a camera, or may be data stored in the memory 30. The VR client 11 sends the N^{th}-frame image data of the drawing graphic to the VR core processing element 12. After receiving the N^{th}-frame image data of the drawing graphic, the VR core processing element 12 sends a drawing instruction including the N^{th}-frame image data of the first drawing graphic to the receiving apparatus 71. The receiving apparatus 71 sends the received drawing instruction to the second GPU 72 such that the second GPU 72 establishes the N^{th}-frame image of the first drawing graphic based on the N^{th}-frame image data of the first drawing graphic included in the drawing instruction. After sending the drawing instruction to the receiving apparatus 71, the VR core processing element 12 sends the N^{th}-frame image data of the second drawing graphic to the first GPU 20 in a form of an instruction such that the first GPU 20 establishes the N^{th}-frame image of the second drawing graphic based on the N^{th}-frame image data of the second drawing graphic. The VR core processing element 12 controls the first GPU 20 to send the N^{th}-frame image of the second drawing graphic to the second display 62, and controls the second GPU 72 to send the N^{th}-frame image of the first drawing graphic to the first display 61 such that the second display 62 displays the N^{th}-frame image of the second drawing graphic, and the first display 61 synchronously displays the N^{th}-frame image of the first drawing graphic.

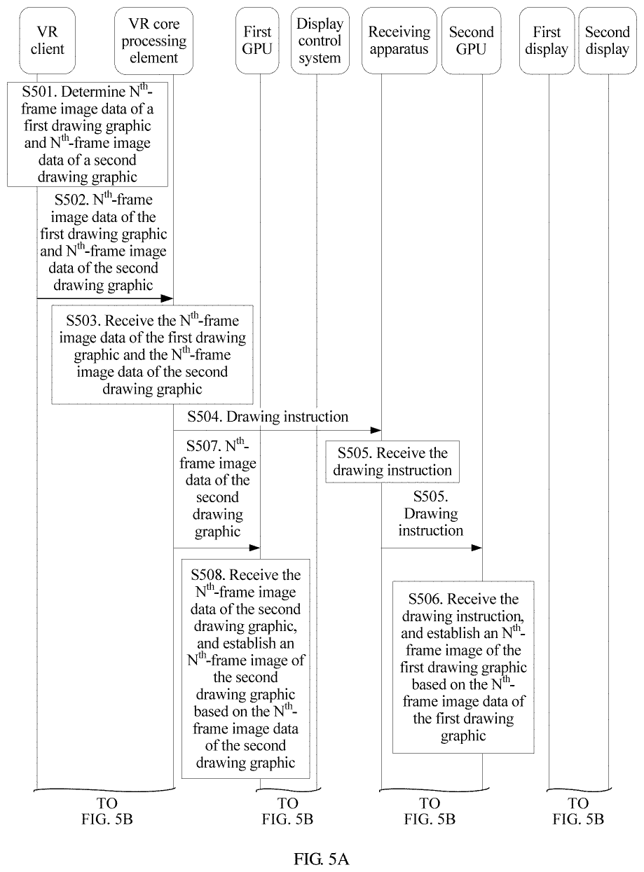

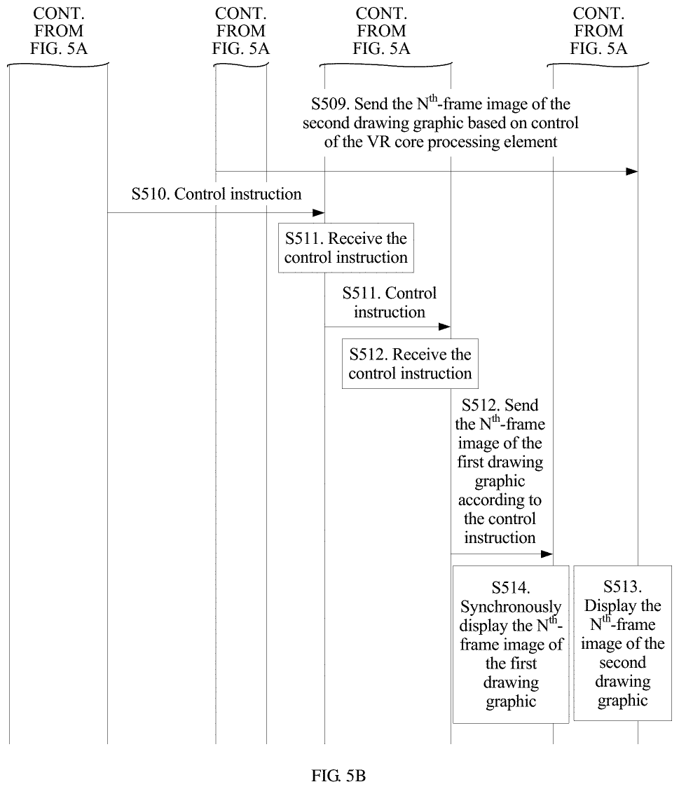

Based on the VR drawing system shown in FIG. 2 and an interaction process between modules or components in FIG. 4, an embodiment of the present disclosure provides a VR drawing method. An interaction process between the terminal device 01 and the VR device 03 in the VR drawing system shown in FIG. 2 is described in detail in the method. Further, as shown in FIG. 5A and FIG. 5B, the VR drawing method may include steps S501 to S514.

Step S501. A VR client determines N^{th}-frame image data of a first drawing graphic and N^{th}-frame image data of a second drawing graphic.

N is a positive integer greater than or equal to 1. The VR client may determine the N^{th}-frame image data of the first drawing graphic and the N^{th}-frame image data of the second drawing graphic according to an operation instruction of a user.

For example, the VR client may retrieve the N^{th}-frame image data of the first drawing graphic and the N^{th}-frame image data of the second drawing graphic from data stored in a memory of a terminal device according to the operation instruction of the user. The VR client may alternatively receive sensor data (data collected by the sensor) transmitted by a VR device, and determine the N^{th}-frame image data of the first drawing graphic and the N^{th}-frame image data of the second drawing graphic that are corresponding to the sensor data.

For example, a user wears a VR device, and enables a VR client in a mobile phone. It is assumed that after the VR client is enabled, a current picture (two dimensional (2D)) displayed on a screen of the mobile phone is an N^{th}-frame image of a drawing graphic. The VR client may retrieve N^{th}-frame image data of the drawing graphic (that is, the N^{th}-frame image data of the first drawing graphic and the N^{th}-frame image data of the second drawing graphic) from image data of each frame of the drawing graphic stored in the memory of the mobile phone.

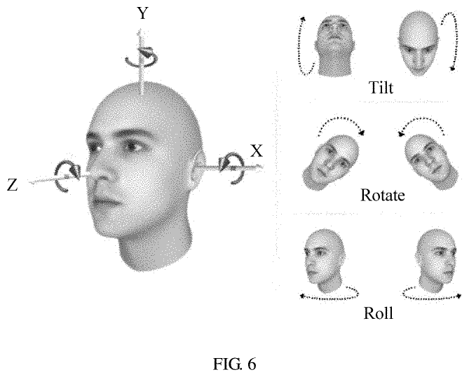

Alternatively, after wearing the VR device, the user may change an angle of viewing the drawing graphic through head turning or moving. As shown in FIG. 6, the user may change the angle of viewing the drawing graphic using a pitch, that is, a manner in which the head turns around an X-axis, or using a yaw, that is, a manner in which the head turns around a Y-axis, or using a roll, that is, a manner in which the head turns around a Z-axis. When the head of the user turns or moves, a sensor of the VR device collects sensor data, and transmits the collected sensor data to the VR client. The VR client retrieves, based on the sensor data, the N^{th}-frame image data of the drawing graphic corresponding to the sensor data from image data of each frame of the drawing graphic stored in the memory of the mobile phone.

In this embodiment of the present disclosure, the N^{th}-frame image data of the first drawing graphic and the N^{th}-frame image data of the second drawing graphic may include an angle of viewing the N^{th}-frame image of the drawing graphic by the user, vertex data, coordinate data, and the like.

Step S502. The VR client sends the N^{th}-frame image data of the first drawing graphic and the N^{th}-frame image data of the second drawing graphic to a VR core processing element.

The VR core processing element is a control center of the terminal device, and the VR client may send the N^{th}-frame image data of the drawing graphic to the VR core processing element such that the VR core processing element can control one or more GPUs to establish the N^{th}-frame image of the drawing graphic based on the N^{th}-frame image data of the drawing graphic.

Step S503. The VR core processing element receives the N^{th}-frame image data of the first drawing graphic and the N^{th}-frame image data of the second drawing graphic.

Step S504. The VR core processing element sends a drawing instruction to a receiving apparatus.

The drawing instruction includes the N^{th}-frame image data of the first drawing graphic. The drawing instruction is used to instruct a second GPU in the VR device to establish an N^{th}-frame image of the first drawing graphic. After receiving the N^{th}-frame image data of the first drawing graphic and the N^{th}-frame image data of the second drawing graphic, the VR core processing element sends the N^{th}-frame image data of the first drawing graphic to the receiving apparatus in the VR device in a form of an instruction.

For example, the terminal device may transmit the drawing instruction to the VR device in a wired connection manner. Alternatively, the terminal device may transmit the drawing instruction to the VR device in a wireless connection manner.

For example, the terminal device may transmit the drawing instruction to the VR device using at least one of a communications interface (a communications interface between the terminal device and the VR device) or a universal serial bus (USB). For details, refer to the communications interface 50 and the receiving apparatus 71. The terminal device may transmit the drawing instruction to the VR device by establishing a real-time network link with the VR device.

Step S505. The receiving apparatus receives the drawing instruction, and sends the drawing instruction to a second GPU.

Step S506. The second GPU receives the drawing instruction, and establishes the N^{th}-frame image of the first drawing graphic based on the N^{th}-frame image data of the first drawing graphic.

Generally, a process of establishing the N^{th}-frame image of the first drawing graphic by the GPU is vertex processing, that is, determining a shape and a location relationship of the N^{th}-frame image of the drawing graphic based on the N^{th}-frame image data of the drawing graphic, and establishing a framework (for example, a polygon) of the N^{th}-frame image of the drawing graphic, rasterization calculation, that is, mapping the N^{th}-frame image of the drawing graphic to a corresponding pixel using an algorithm, pixel processing, that is, completing pixel calculation and processing during rasterization processing on each pixel, to determine a final attribute of each pixel, and texturing, that is, performing coloring processing to complete a texture of a polygon surface. Generally speaking, the polygon surface is attached with a corresponding picture, to generate a “real” graphic.

For example, the N^{th}-frame image data of the first drawing graphic in the drawing instruction includes an angle, vertex data, and coordinate data of the N^{th}-frame image of the first drawing graphic. The second GPU establishes a sphere based on the angle, the vertex data, and the coordinate data of the N^{th}-frame image of the first drawing graphic, maps the sphere to a corresponding pixel, and performs coloring processing on the sphere to obtain a sphere of a 3D effect.

Step S507. The VR core processing element sends the N^{th}-frame image data of the second drawing graphic to the first GPU.

After sending the drawing instruction to the receiving apparatus of the VR device, the VR core processing element sends the N^{th}-frame image data of the second drawing graphic to the first GPU in a form of an instruction.

For example, the N^{th}-frame image data of the second drawing graphic includes an angle, vertex data, and coordinate data of an N^{th}-frame image of the second drawing graphic.

Step S508. The first GPU receives the N^{th}-frame image data of the second drawing graphic, and establishes the N^{th}-frame image of the second drawing graphic based on the N^{th}-frame image data of the second drawing graphic.

For example, the first GPU may establish another sphere based on the angle, the vertex data, and the coordinate data of the N^{th}-frame image of the second drawing graphic, map the sphere to a corresponding pixel, and perform coloring processing on the sphere to obtain a sphere of a 3D effect.

In this embodiment of the present disclosure, the N^{th}-frame image of the first drawing graphic is established by the second GPU in the VR device, the N^{th}-frame image of the second drawing graphic is established by the first GPU in the terminal device, and the second GPU and the first GPU process the N^{th}-frame image data of the drawing graphic in parallel. Therefore, a time used for establishing the N^{th}-frame image of the drawing graphic using only one GPU can be reduced.

Step S509. The first GPU sends the N^{th}-frame image of the second drawing graphic to a second display based on control of the VR core processing element.

The VR core processing element may learn a moment at which the first GPU completes establishment of the N^{th}-frame image of the second drawing graphic. After the first GPU completes the establishment of the N^{th}-frame image of the second drawing graphic, the VR core processing element controls the first GPU to send the N^{th}-frame image of the second drawing graphic to the second display in the VR device.

Further, a first display control system is disposed in the terminal device, and the VR core processing element may control the first GPU to send the N^{th}-frame image of the second drawing graphic to the first display control system. The first display control system processes the N^{th}-frame image of the second drawing graphic. To be specific, the first display control system scans each pixel in the N^{th}-frame image of the second drawing graphic, and transmits a result of the scanning to the second display in the VR device.

For example, it is assumed that the first GPU completes the establishment of the N^{th}-frame image of the second drawing graphic at a moment t1, the second GPU completes establishment of the N^{th}-frame image of the first drawing graphic at a moment t2, and an N^{th} display moment preset by the VR core processing element (that is, a moment at which the display of the VR device displays the N^{th}-frame image of the drawing graphic) is a moment t3. The VR core processing element controls the first GPU to send the N^{th}-frame image of the second drawing graphic to the first display control system at the moment t3 for processing, and the first display control system sends a processed N^{th}-frame image of the second drawing graphic to the second display at the moment t3 (the moment t3 is later than or equal to the moment t2).

It should be noted that there is no time-related relationship between the moment t1 and the moment t2. The moment t1 may be equal to the moment t2, the moment t1 may be earlier than the moment t2, or the moment t1 may be later than the moment t2. Herein, that the moment t1 is earlier than the moment t2 is used only as an example to describe a moment at which the VR core processing element controls the first GPU to send the Nth-frame image of the second drawing graphic. In addition, a time period from sending the Nth-frame image of the second drawing graphic by the first GPU, to processing the Nth-frame image of the second drawing graphic by the first display control system, and then sending the processed Nth-frame image of the second drawing graphic to the second display is quite short, and may be ignored.

Step S510. The VR core processing element sends a control instruction to the receiving apparatus.

After the second GPU completes the establishment of the N^{th}-frame image of the first drawing graphic, the VR core processing element sends the control instruction to the receiving apparatus of the VR device at the preset N^{th} display moment.

For example, the VR core processing element may send the control instruction to the receiving apparatus at the moment t3.

Step S511. The receiving apparatus receives the control instruction, and sends the control instruction to the second GPU.

The control instruction is used to instruct the second GPU to send the N^{th}-frame image of the first drawing graphic to the display in the VR device.

Step S512. The second GPU receives the control instruction, and sends the N^{th}-frame image of the first drawing graphic to a first display according to the control instruction.

Further, a second display control system is disposed in the VR device, and the VR core processing element may control, by sending a control instruction, the second GPU to send the N^{th}-frame image of the first drawing graphic to the second display control system. The second display control system processes the N^{th}-frame image of the first drawing graphic, that is, scans each pixel of the N^{th}-frame image of the first drawing graphic, and transmits a result of the scanning to the first display in the VR device. The second display control system in this embodiment of the present disclosure may be the display control system 80 shown in FIG. 2 or FIG. 3.

For example, the VR core processing element may control the second GPU to send the N^{th}-frame image of the first drawing graphic to the second display control system at the moment t3 for processing, and the second display control system sends a processed N^{th}-frame image of the first drawing graphic to the first display at the moment t3.

Step S513. The second display displays the N^{th}-frame image of the second drawing graphic.

Step S514. The first display synchronously displays the N^{th}-frame image of the first drawing graphic.

The N^{th}-frame image of the second drawing graphic and the N^{th}-frame image of the first drawing graphic are used to form an N^{th}-frame VR image on the first display 61 and the second display 62.

For example, the first display and the second display both display the N^{th}-frame VR image at the moment t3.

According to the VR drawing method provided in this embodiment of the present disclosure, the first GPU in the terminal device and the second GPU in the VR device may respectively establish the N^{th}-frame image of the second drawing graphic and the N^{th}-frame image of the first drawing graphic, and the first GPU and the second GPU may establish the N^{th}-frame image of the second drawing graphic and the N^{th}-frame image of the first drawing graphic in parallel. Therefore, according to the method in this embodiment of the present disclosure, a time used for establishing the N^{th}-frame image of the drawing graphic is reduced, and a drawing graphic processing capability is improved. In addition, the VR core processing element is used to control the first GPU and the second GPU to synchronously send the N^{th}-frame images of the drawing graphics to the displays of the VR device such that the first display and the second display synchronously display the N^{th}-frame VR image.

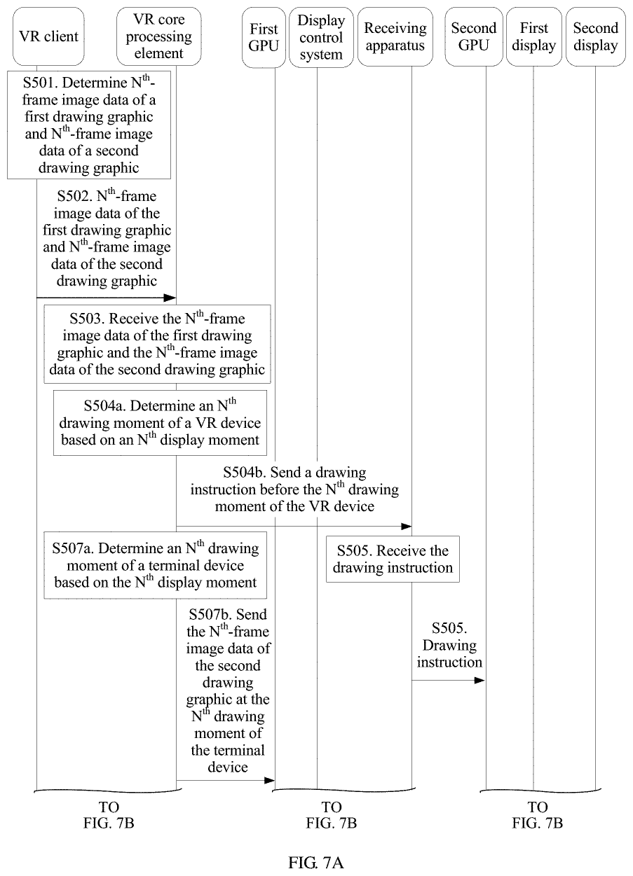

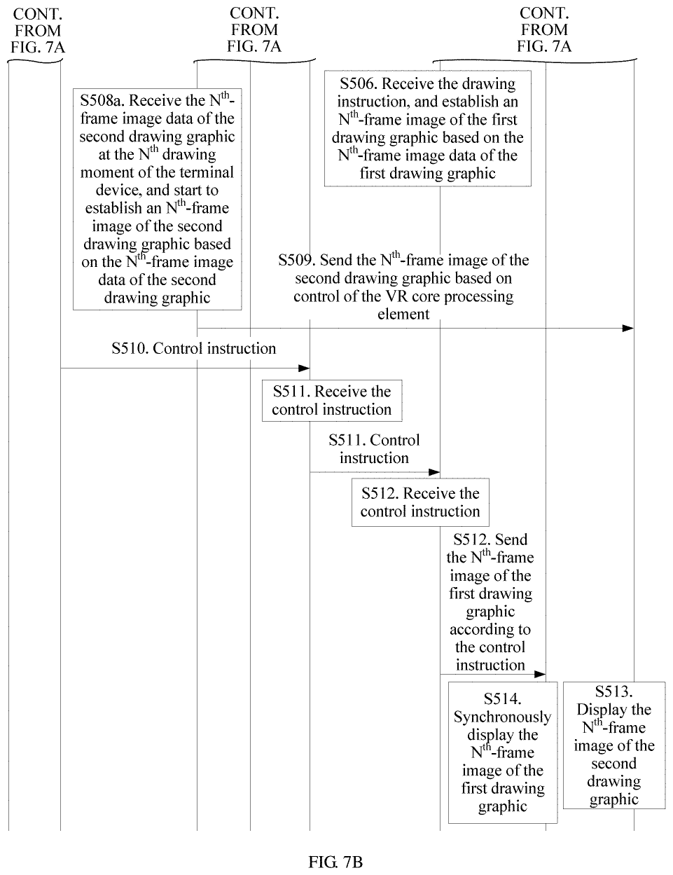

Further, the control instruction in this embodiment of the present disclosure may include the N^{th} display moment. The VR core processing element may determine, based on the N^{th} display moment, a moment for sending the drawing instruction to the VR device and a moment for establishing the N^{th}-frame image of the second drawing graphic using the first GPU. Correspondingly, FIG. 7A and FIG. 7B show another VR drawing method according to an embodiment of the present disclosure. In comparison with the VR drawing method shown in FIG. 5A and FIG. 5B, step S504 is replaced with steps S504a and S504b, step S507 is replaced with steps S507a and S507b, and step S508 is replaced with step S508a. Only a difference is described in detail herein. Referring to FIG. 7A and FIG. 7B, the method includes the following steps.

Step S501. A VR client determines N^{th}-frame image data of a first drawing graphic and N^{th}-frame image data of a second drawing graphic.

Step S502. The VR client sends the N^{th}-frame image data of the first drawing graphic and the N^{th}-frame image data of the second drawing graphic to a VR core processing element.

Step S503. The VR core processing element receives the N^{th}-frame image data of the first drawing graphic and the N^{th}-frame image data of the second drawing graphic.

Step S504a. The VR core processing element determines an N^{th} drawing moment of a VR device based on an N^{th} display moment.

The VR core processing element may obtain duration used by a second GPU to establish an N^{th}-frame image of the first drawing graphic, and determine, based on the N^{th} display moment (that is, a moment at which the VR device displays the N^{th}-frame image of the first drawing graphic and an N^{th}-frame image of the second drawing graphic), the N^{th} drawing moment of the VR device (that is, a moment at which the second GPU starts to establish the N^{th}-frame image of the first drawing graphic) such that the N^{th} drawing moment of the VR device is earlier than the N^{th} display moment, and duration between the N^{th} drawing moment and the N^{th} display moment is greater than or equal to the duration used by the second GPU to establish the N^{th}-frame image of the first drawing graphic.

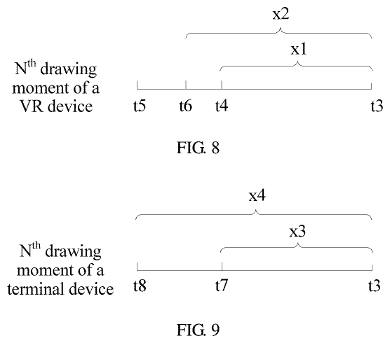

For example, as shown in FIG. 8, it is assumed that the N^{th} display moment is a moment t3, and the duration (referred to as first duration) that is obtained by the VR core processing element and that is used by the second GPU to establish the N^{th}-frame image of the first drawing graphic is x1 milliseconds (ms), for example, duration from a moment t4 to the moment t3 in FIG. 8. The N^{th} drawing moment of the VR device determined by the VR core processing element is any moment (for example, a moment t6) from a moment t5 to the moment t4. The moment t6 is earlier than the moment t3, and duration x2 between the moment t6 and the moment t3 is greater than x1.

Step S504b. The VR core processing element sends a drawing instruction to a receiving apparatus before the N^{th} drawing moment of the VR device.

For example, the VR core processing element may send the drawing instruction to the receiving apparatus before the moment t6 shown in FIG. 8.

Step S505. The receiving apparatus receives the drawing instruction, and sends the drawing instruction to the second GPU.

Step S506. The second GPU receives the drawing instruction, and establishes the N^{th}-frame image of the first drawing graphic based on the N^{th}-frame image data of the first drawing graphic.

Step S507a. The VR core processing element determines an N^{th} drawing moment of a terminal device based on the N^{th} display moment.

The VR core processing element may obtain duration used by a first GPU to establish the N^{th}-frame image of the second drawing graphic, and determine the N^{th} drawing moment of the terminal device (that is, a moment at which the first GPU starts to establish the N^{th}-frame image of the second drawing graphic) based on the N^{th} display moment. The N^{th} drawing moment of the terminal device is earlier than the N^{th} display moment, and duration between the N^{th} drawing moment and the N^{th} display moment is greater than or equal to the duration used by the first GPU to establish the N^{th}-frame image of the second drawing graphic.

For example, as shown in FIG. 9, it is assumed that the N^{th} display moment is a moment t3, and the duration (referred to as second duration) that is obtained by the VR core processing element and that is used by the first GPU to establish the N^{th}-frame image of the second drawing graphic is x3 (ms), for example, duration from a moment t7 to the moment t3 in FIG. 9. The N^{th} drawing moment of the terminal device determined by the VR core processing element is any moment (for example, a moment t8) from the moment t8 to the moment t7, the moment t8 is earlier than the moment t3, and duration x4 between the moment t8 and the moment t3 is greater than x3.

Step S507b. The VR core processing element sends the N^{th}-frame image data of the second drawing graphic to the first GPU at the N^{th} drawing moment of the terminal device.

For example, the VR core processing element may send the N^{th}-frame image data of the second drawing graphic to the first GPU at the moment t8 shown in FIG. 9.

It should be noted that a time period from sending the N^{th}-frame image of the second drawing graphic to the first GPU by the VR core processing element to receiving the N^{th}-frame image of the second drawing graphic by the first GPU is quite short, and may be ignored.

Step S508a. The first GPU receives the N^{th}-frame image data of the second drawing graphic at the N^{th} drawing moment of the terminal device, and starts to establish the N^{th}-frame image of the second drawing graphic based on the N^{th}-frame image data of the second drawing graphic.

Step S509. The first GPU sends the N^{th}-frame image of the second drawing graphic to a second display based on control of the VR core processing element.

Step S510. The VR core processing element sends a control instruction to the receiving apparatus.

Step S511. The receiving apparatus receives the control instruction, and sends the control instruction to the second GPU.

Step S512. The second GPU receives the control instruction, and sends the N^{th}-frame image of the first drawing graphic to a first display according to the control instruction.

Step S513. The second display displays the N^{th}-frame image of the second drawing graphic.

Step S514. The first display synchronously displays the N^{th}-frame image of the first drawing graphic.

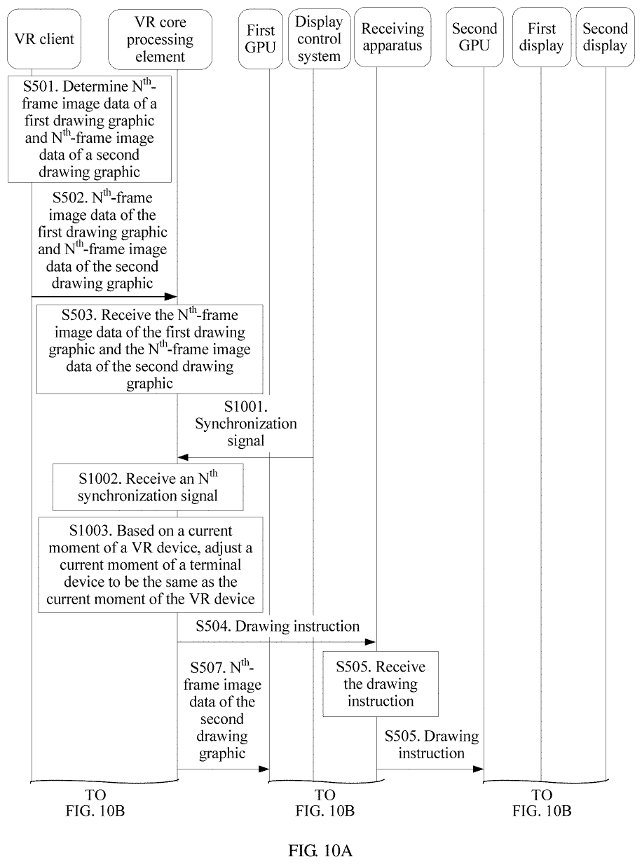

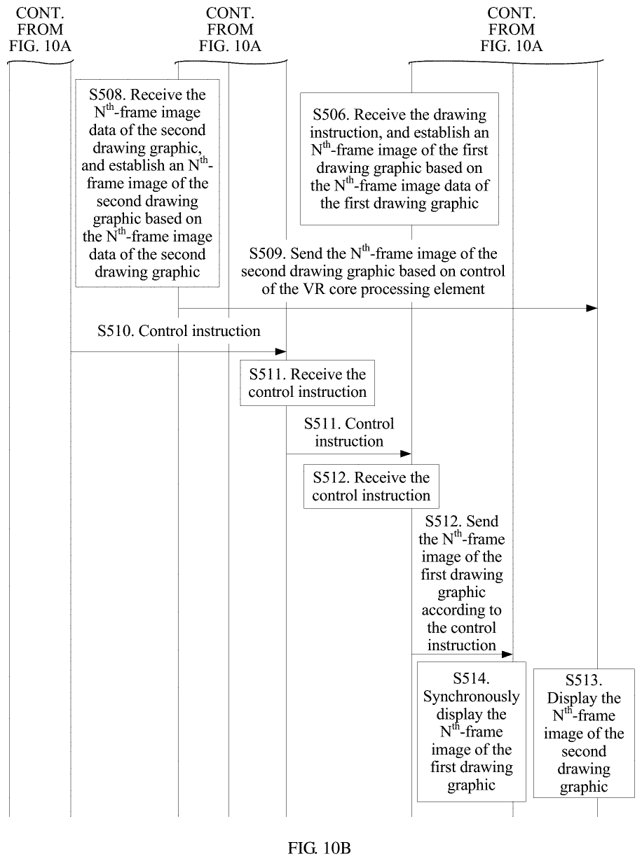

Further, the VR core processing element may adjust, based on a synchronization signal sent by a display control system in the VR device, a current moment of the terminal device to be the same as a current moment of the VR device, to ensure that the first display and the second display can synchronously display an N^{th}-frame VR image at the N^{th} display moment. Further, in comparison with the VR drawing method shown in FIG. 5A and FIG. 5B or FIG. 7A and FIG. 7B, steps S1001 to S1003 are mainly added before step S504 or step S504b. FIG. 10A and FIG. 10B show another VR drawing method according to an embodiment of the present disclosure in comparison with the VR drawing method shown in FIG. 5A and FIG. 5B. The method includes the following steps.

Step S1001. A display control system sends a synchronization signal to a VR core processing element.

The display control system may send the synchronization signal to the VR core processing element each time a display of a VR device displays an image of a drawing graphic.

Step S1002. The VR core processing element receives an N^{th} synchronization signal.

The synchronization signal includes a current moment of the VR device, and the synchronization signal is used to synchronize a current moment of a terminal device.

Step S1003. The VR core processing element adjusts, based on the current moment of the VR device, the current moment of the terminal device to be the same as the current moment of the VR device.

The current moment of the terminal device may be different from the current moment of the VR device. As a result, when the VR core processing element sends a control instruction to the VR device, an N^{th} display moment included in the control instruction may be different from an N^{th} display moment of the VR device, and consequently, displays of the VR device cannot separately and synchronously display an N^{th}-frame image of a first drawing graphic and an N^{th}-frame image of a second drawing graphic at the N^{th} display moment. If a time adjustment method provided in this embodiment of the present disclosure is used, after the terminal device adjusts the current moment of the terminal device to be the same as the current moment of the VR device, it can be ensured that when the terminal device sends the N^{th}-frame image of the second drawing graphic and the control instruction to the VR device, the VR device can synchronously display the N^{th}-frame image of the second drawing graphic and the N^{th}-frame image of the first drawing graphic at the N^{th} display moment.

The foregoing mainly describes the solutions provided in the embodiments of the present disclosure from perspectives of a terminal device and a VR device. It can be understood that, to implement the foregoing functions, the terminal device and the VR device each include a hardware structure or a software module corresponding to each function. A person skilled in the art should easily be aware that, with reference to the terminal device and the VR device and algorithms steps in the examples described in the embodiments disclosed in this specification, each function of each device can be implemented by hardware or a combination of hardware and computer software. Whether a function is performed by hardware or hardware driven by computer software depends on particular applications and design constraints of the technical solutions. A person skilled in the art can implement the described functions using different methods for each specific application.

With reference to related method steps in FIG. 2, FIG. 5A and FIG. 5B, FIG. 7A and FIG. 7B, and FIG. 10A and FIG. 10B, the VR client 11 is configured to support steps S501 and S502 in the foregoing embodiment, or is further used in another process of the technology described in this specification. The VR core processing element 12 is configured to support steps S503, S504, S507, S509, S510, S504a, S504b, S507a, S507b, S1002, and S1003 in the foregoing embodiment, or is further used in another process of the technology described in this specification. The first GPU 20 is configured to support steps S508 and S508a in the foregoing embodiment, or is further used in another process of the technology described in this specification.

The receiving apparatus 71 is configured to support steps S505 and S511 in the foregoing embodiment, or is further used in another process of the technology described in this specification. The second GPU 72 is configured to support steps S506 and S512 in the foregoing embodiment, or is further used in another process of the technology described in this specification. The first display 51 is configured to support step S514 in the foregoing embodiment, or is further used in another process of the technology described in this specification. The second display 62 is configured to support step S513 in the foregoing embodiment, or is further used in another process of the technology described in this specification. The display control system 80 is configured to support step S1001 in the foregoing embodiment, or is further used in another process of the technology described in this specification.

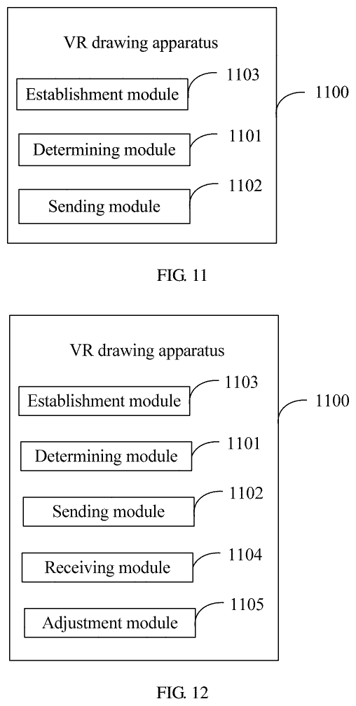

FIG. 11 is a possible schematic diagram of an embodiment of a VR drawing apparatus 1100. The VR drawing apparatus 1100 may include a determining module 1101, a sending module 1102, and an establishment module 1103. A function of the determining module 1101 may be implemented using the processor 10 shown in FIG. 2. A function of the sending module 1102 may be implemented using the communications interface 50 shown in FIG. 2. A function of the establishment module 1103 may be implemented using the first GPU 20 shown in FIG. 2. Further, as shown in FIG. 12, the VR drawing apparatus 1100 shown in FIG. 11 may further include a receiving module 1104 and an adjustment module 1105. A function of the receiving module 1104 may be implemented using the communications interface 50 shown in FIG. 2. A function of the adjustment module 1105 may be implemented using the processor 10 shown in FIG. 2. Optionally, the determining module 1101, the sending module 1102, the establishment module 1103, the receiving module 1104, and the adjustment module 1105 may be implemented by software or a combination of software and hardware. Certainly, the VR drawing apparatus 1100 provided in this embodiment of the present disclosure includes but is not limited to the foregoing modules. For example, the VR drawing apparatus 1100 may further include a storage module. The storage module may be configured to store N^{th}-frame image data of a first drawing graphic and N^{th}-frame image data of a second drawing graphic in this embodiment of the present disclosure. A function of the storage module may be implemented using the memory 30 shown in FIG. 2.

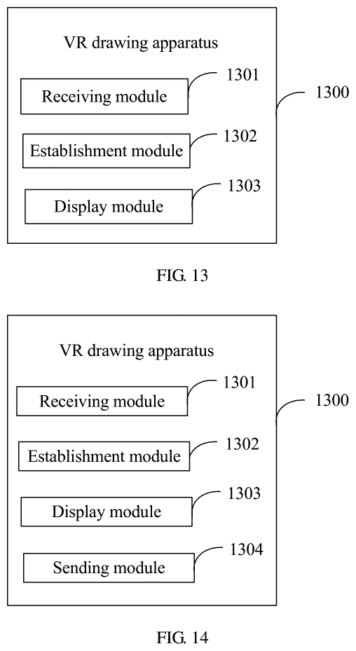

FIG. 13 is another possible schematic diagram of an embodiment of a VR drawing apparatus 1300. The VR drawing apparatus 1300 includes a receiving module 1301, an establishment module 1302, and a display module 1303. A function of the receiving module 1301 may be implemented using the receiving apparatus 71 shown in FIG. 2. A function of the establishment module 1302 may be implemented using the second GPU 72 shown in FIG. 2. A function of the display module 1303 may be implemented using the first display 61 and the second display 62 shown in FIG. 2. Further, as shown in FIG. 14, the VR drawing apparatus 1300 shown in FIG. 13 may further include a sending module 1304. A function of the sending module 1304 may be implemented using the receiving apparatus 71 shown in FIG. 2. Optionally, the receiving module 1301, the establishment module 1302, the display module 1303, and the sending module 1304 may be implemented using software or a combination of software and hardware.

Certainly, the VR drawing apparatus 1300 provided in this embodiment of the present disclosure includes but is not limited to the foregoing modules. For example, the VR drawing apparatus 1300 may further include a storage module. The storage module may be configured to store an N^{th}-frame image of a first drawing graphic in this embodiment of the present disclosure.

Based on the foregoing descriptions of the implementations, a person skilled in the art can clearly understand that, for convenience and brevity of description, division of the foregoing function modules is merely used as an example for illustration. In actual application, the foregoing functions may be allocated to different function modules and implemented according to a requirement, that is, an inner structure of an apparatus is divided into different function modules to implement all or some of the functions described above. For a detailed working process of the foregoing system, apparatus, and unit, refer to a corresponding process in the foregoing method embodiments, and details are not described herein again.

An embodiment of the method procedure in the present disclosure may be stored in a computer readable storage medium if the embodiment is implemented in a form of a software function unit and is sold or used as an independent product. Therefore, an embodiment of the present disclosure further provides a computer storage medium. The computer storage medium stores program code of one or more parts. When at least one of the processor 10, the communications interface 50, the first GPU 20, the second GPU 72, and the receiving apparatus 71 in FIG. 2 executes the program code, the terminal device 01 or the VR device 03 shown in FIG. 2 is driven to perform a method step related to a corresponding device in any one of FIG. 5A and FIG. 5B, FIG. 7A and FIG. 7B, and FIG. 10A and FIG. 10B.

Based on such an understanding, all or some of the processes of the related method embodiments may be implemented in a form of a computer software product. The computer software product is stored in a storage medium and includes several instructions for instructing a computer device or at least one processor to perform all or some of the steps of the methods described in the embodiments of the present disclosure. The storage medium includes any medium that can store program code, for example, a USB flash drive, a removable hard disk, a read-only memory (ROM), a random access memory (RAM), a magnetic disk, or a compact disc.

The foregoing descriptions are merely specific implementations of the present disclosure, but are not intended to limit the protection scope of the present disclosure. Any variation or replacement within the technical scope disclosed in the present disclosure shall fall within the protection scope of the present disclosure. Therefore, the protection scope of the present disclosure shall be subject to the protection scope of the claims.

What is claimed is:

1. A virtual reality (VR) drawing method, implemented by a terminal device, comprising:
determining first N^{th}-frame image data of a first drawing graphic and second N^{th}-frame image data of a second drawing graphic;
sending a drawing instruction to a VR device to instruct the VR device to establish, using a second graphics processing unit (GPU) in the VR device, a first N^{th}-frame image of the first drawing graphic based on the first N^{th}-frame image data, wherein the drawing instruction comprises the first N^{th}-frame image data;
creating, using a first GPU in the terminal device, a second N^{th}-frame image of the second drawing graphic based on the second N^{th}-frame image data;
sending the second N^{th}-frame image to the VR device to enable the VR device to display the second N^{th}-frame image; and
sending a control instruction to the VR device to instruct the VR device to synchronously display the first N^{th}-frame image and the second N^{th}-frame image to form a VR image.

2. The VR drawing method of claim 1, wherein the control instruction comprises an N^{th} display moment, and wherein sending the drawing instruction to the VR device comprises:
determining a first N^{th} drawing moment of the VR device based on the N^{th} display moment, wherein the first N^{th} drawing moment is earlier than the N^{th} display moment, and wherein a duration between the first N^{th} drawing moment and the N^{th} display moment is greater than or equal to a duration used by the second GPU to create the first N^{th}-frame image; and
sending the drawing instruction to the VR device before the first N^{th} drawing moment.

3. The VR drawing method of claim 1, wherein the control instruction comprises an N^{th} display moment, and wherein creating the second N^{th}-frame image comprises:
determining a second N^{th} drawing moment of the terminal device based on the N^{th} display moment, wherein the second N^{th} drawing moment is earlier than the N^{th} display moment, and wherein a duration between the second N^{th} drawing moment and the N^{th} display moment is greater than or equal to a duration used by the first GPU to create the second N^{th}-frame image; and
creating, starting from the second N^{th} drawing moment using the first GPU, the second N^{th}-frame image based on the second N^{th}-frame image data.

4. The VR drawing method of claim 1, wherein before sending the drawing instruction to the VR device, the VR drawing method further comprises:
receiving a synchronization signal from the VR device, wherein the synchronization signal comprises a first current moment of the VR device; and
adjusting, based on the first current moment, a second current moment of the terminal device to be the same as the first current moment.

5. The VR drawing method of claim 1, wherein determining the first N^{th}-frame image data and the second N^{th}-frame image data comprises:
receiving sensor data from the VR device; and
determining the first N^{th}-frame image data and the second N^{th}-frame image data from the sensor data.

6. A virtual reality (VR) drawing method, implemented by a VR device, comprising:
receiving a drawing instruction from a terminal device, wherein the drawing instruction comprises first N^{th}-frame image data of a first drawing graphic, and wherein N is a positive integer greater than or equal to one;
creating, using a second graphics processing unit (GPU) in the VR device, a first N^{th}-frame image of the first drawing graphic based on the first N^{th}-frame image data;
receiving a second N^{th}-frame image of a second drawing graphic from the terminal device;
receiving a control instruction from the terminal device;
synchronously displaying the first N^{th}-frame image and the second N^{th} frame image according to the control instruction, wherein the second N^{th}-frame image and the first N^{th}-frame image are used to form an N^{th}-frame VR image.

7. The VR drawing method of claim 6, wherein the control instruction comprises an N^{th} display moment, wherein creating the first N^{th}-frame image comprises creating, starting from a first N^{th} drawing moment of the VR device using the second GPU, the first N^{th}-frame image based on the first N^{th}-frame image data, wherein the first N^{th} drawing moment is earlier than the N^{th} display moment, and wherein a duration between the first N^{th} drawing moment and the N^{th} display moment is greater than or equal to a duration used by the second GPU to create the first N^{th}-frame image.

8. The VR drawing method of claim 6, wherein before receiving the drawing instruction, the VR drawing method further comprises sending a synchronization signal to the terminal device, wherein the synchronization signal comprises a first current moment of the VR device, and wherein the synchronization signal enables the terminal device to synchronize a second current moment of the terminal device.

9. The VR drawing method of claim 6, wherein before creating the first N^{th}-frame image, the VR drawing method further comprises sending sensor data to the terminal device to enable the terminal device to determine the first N^{th}-frame image data and second N^{th}-frame image data.

10. A virtual reality (VR) drawing apparatus, comprising:
a processor configured to:
determine first N^{th}-frame image data of a first drawing graphic and second N^{th}-frame image data of a second drawing graphic, wherein N is a positive integer greater than or equal to one; and
generate a drawing instruction, wherein the drawing instruction comprises the first N^{th}-frame image data;
a communications interface coupled to the processor and configured to send the drawing instruction to a VR device to instruct the VR device to create, using a second graphics processing unit (GPU) in the VR device, a first N^{th}-frame image of the first drawing graphic based on the first N^{th}-frame image data; and
a first GPU coupled to the processor and the communications interface and configured to create a second N^{th}-frame image of the second drawing graphic based on the second N^{th}-frame image data,
wherein the communications interface is further configured to:
send the second N^{th}-frame image to the VR device to enable the VR device to display the second N^{th}-frame image; and
send a control instruction to the VR device to instruct the VR device to synchronously display the first N^{th}-frame image and the second N^{th} frame image, wherein the second N^{th}-frame image and the first N^{th}-frame image are used to form an N^{th}-frame VR image.

11. The VR drawing apparatus of claim 10, wherein the control instruction comprises an N^{th} display moment, wherein the processor is further configured to determine a first N^{th} drawing moment of the VR device based on the N^{th} display moment, wherein the first N^{th} drawing moment is earlier than the N^{th} display moment, wherein a duration between the first N^{th} drawing moment and the N^{th} display moment is greater than or equal to a duration used by the second GPU to create the first N^{th}-frame image, and wherein the communications interface is further configured to send the drawing instruction to the VR device before the first N^{th} drawing moment.

12. The VR drawing apparatus of claim 10, wherein the control instruction comprises an N^{th} display moment, wherein the processor is further configured to determine a second N^{th} drawing moment of the VR drawing apparatus based on the N^{th} display moment, wherein the second N^{th} drawing moment is earlier than the N^{th} display moment, wherein a duration between the second N^{th} drawing moment and the N^{th} display moment is greater than or equal to a duration used by the first GPU to create the second N^{th}-frame image, and wherein the first GPU is further configured to create, starting from the second N^{th} drawing moment, the second N^{th}-frame image based on the second N^{th}-frame image data.

13. The VR drawing apparatus of claim 10, wherein before sending the drawing instruction to the VR device, the communications interface is further configured to receive a synchronization signal from the VR device, wherein the synchronization signal comprises a first current moment of the VR device, and wherein the processor is further configured to adjust, based on the first current moment, a second current moment of the VR drawing apparatus to be the same as the first current moment.

14. The VR drawing apparatus of claim 10, wherein the communications interface is further configured to receive sensor data from the VR device, and wherein the processor is further configured to determine the first N^{th}-frame image data and the second N^{th}-frame image data from the sensor data.

15. The VR drawing apparatus of claim 10, further comprising a memory, wherein the memory is configured to store a computer executable instruction, wherein the processor, the communications interface, the first GPU, and the memory are coupled to each other using a bus, and wherein the processor is further configured to execute the computer executable instruction stored in the memory when the VR drawing apparatus is running.

16. A virtual reality (VR) drawing apparatus, comprising:
a communications interface configured to receive a drawing instruction from a terminal device, wherein the drawing instruction comprises first N^{th}-frame image data of a first drawing graphic, and wherein N is a positive integer greater than or equal to one;
a graphics processing unit (GPU) coupled to the communications interface and configured to create a first N^{th}-frame image of the first drawing graphic based on the first N^{th}-frame image data,
wherein the communications interface is further configured to:
receive a second N^{th}-frame image of a second drawing graphic from the terminal device; and
receive a control instruction from the terminal device; and
a display component coupled to the communications interface and configured to synchronously display the first N^{th}-frame image and the second N^{th} frame image according to the control instruction, wherein the second N^{th}-frame image and the first N^{th}-frame image are used to form an N^{th}-frame VR image.

17. The VR drawing apparatus of claim 16, wherein the control instruction comprises an N^{th} display moment, wherein the GPU is further configured to create, starting from a first N^{th} drawing moment of the VR drawing apparatus, the first N^{th}-frame image based on the first N^{th}-frame image data, wherein the first N^{th} drawing moment is earlier than the N^{th} display moment, and wherein a duration between the first N^{th} drawing moment and the N^{th} display moment is greater than or equal to a duration used by the GPU to create the first N^{th}-frame image.

18. The VR drawing apparatus of claim 16, wherein before receiving the drawing instruction, the communications interface is further configured to send a synchronization signal to the terminal device, wherein the synchronization signal comprises a first current moment of the VR drawing apparatus, and wherein the synchronization signal enables the terminal device to synchronize a second current moment of the terminal device.

19. The VR drawing apparatus of claim 16, further comprising a sensor, wherein the sensor is configured to obtain sensor data before the GPU creates the first N^{th}-frame image based on the first N^{th}-frame image data, and wherein the communications interface is further configured to send the sensor data to the terminal device to enable the terminal device to determine the first N^{th}-frame image data and second N^{th}-frame image data of the second drawing graphic.

20. The VR drawing apparatus of claim 16, further comprising a processor coupled to the communications interface and configured to:
predict an angle of viewing the first drawing graphic and an angle of viewing the second drawing graphic of a user to obtain a prediction result; and
send the prediction result to the terminal device.
